(19) United States
(12) Patent Application Publication
(10) Pub. No.: US 2007/0211052 A1
(43) Pub. Date: Sep. 13, 2007

(54) System, method and media processing 3-dimensional graphic data

(75) Inventors: Se-yoon Tak, Yongin-si (KR); Do-Kyoon Kim, Yongin-si (KR); Kee-chang Lee, Yongin-si (KR); Jeong-hwan Ahn, Yongin-si (KR)

Correspondence Address: STAAS & HALSEY LLP, SUITE 700, 1201 NEW YORK AVENUE, N.W., WASHINGTON, DC, 20005, US

(73) Assignee: SAMSUNG ELECTRONICS CO., LTD., Suwon-si (KR)

(21) Appl. No.: 11/715,378

(22) Filed: Mar. 8, 2007

(30) Foreign Application Priority Data
Mar. 10, 2006 (KR) 10-2006-0022724

(51) Int. Cl. G06T 15/50; G06T 17/00

(52) U.S. Cl. 345/426; 345/420

(57) ABSTRACT

A system, method and medium for processing objects including 3D graphic data, wherein the processing time for converting 3D graphic data into a 2D image can be minimized by aligning and converting the objects of the 3D graphic data into the 2D image based on the appearance information corresponding to the effects information or shader code.

### CROSS-REFERENCE TO RELATED APPLICATIONS

This application claims the benefit of Korean Patent Application No. 10-2006-0022724, filed on Mar. 10, 2006, in the Korean Intellectual Property Office, the disclosure of which is incorporated herein in its entirety by reference.

### BACKGROUND

1. Field

The present invention relates to 3-dimensional (3D) graphic data, and more particularly to a system, method and medium for processing an object to generate the 3D graphic data.

2. Description of the Related Art

3-dimensional (3D) graphic data is typically output to a screen of a device in formats defined by standards such as virtual reality modeling language (VRML), moving picture expert group (MPEG), and general use programs such as 3D Studio Max and Maya, for example. The 3D graphic data includes geometry information (for example, locations and connection information of 3D points constituting the object) of the objects located in 3D space, appearance information of the objects (for example, texture of the object, transparency of the object, color of the objects, and light reflectance of the object surface), and variation information according to a location and characteristics of a light source and time.

FIGS. 1A through 1C are conceptual views for explaining a conventional method for processing 3D graphic data. 3D graphic data representing a person 100 shown in FIG. 1A includes objects such as a chest 110, a left arm 120, a head 130, a right arm 140, a belly 150, a left leg 160, a left foot 170, a right leg 180, and a right foot 190 in a hierarchical structure shown in FIG. 1B. Each object constituting the person 100 includes the geometry information, the appearance information, and the variation information according to the location and the characteristics of the light source and time.

As shown in FIG. 1C, the object including the 3D graphic data is rendered, via a left to right tree traversal, in the order of the chest 110, the left arm 120, the head 130, the right arm 140, the belly 150, the left leg 160, the left foot 170, the right leg 180, and the right foot 190 according to the hierarchical structure based on the geometry information in which each object is included.

However, when the appearance information of an object to be rendered next is different from the appearance information of the object currently being rendered, the hardware setting has to be reset. Therefore, as shown in FIG. 1C, when the appearance information of the objects is arranged so that the appearance information of an object to be rendered next is different from the appearance information of the object currently being rendered, the hardware setting has to be reset whenever each object is rendered, and the overall operation takes more time due to constant resetting of the hardware.

### SUMMARY

One or more embodiments of the present invention provide a system, method and medium for processing 3-dimensional (3D) graphic data capable of converting objects into a 2-dimensional (2D) image by aligning the objects of the 3D graphic data based on appearance information corresponding to effects information or shader code.

Additional aspects and/or advantages of the invention will be set forth in part in the description which follows and, in part, will be apparent from the description, or may be learned by practice of the invention.

To achieve at least the above and/or other aspects and advantage, embodiments of the present invention include a method of processing 3D (3-dimensional) graphic data including classifying and aligning objects based on appearance information, and converting the objects into a 2D image in accordance with the alignment result.

To achieve at least the above and/or other aspects and advantages, embodiments of the present invention include a system for processing 3D (3-dimensional) graphic data. The system includes an object classifier to classify and to align objects based on appearance information, and a converter to convert the objects into a 2D image in accordance with the alignment result.

To achieve at least the above and/or other aspects and advantage, embodiments of the present invention include a method of processing 3D (3-dimensional) graphic data including aligning 3D graphic objects in an order based on an appearance of each of the objects, and converting the objects into a 2D image in the aligned order.

To achieve at least the above and/or other aspects and advantage, embodiments of the present invention include a display including a first set of 2D images converted from a first group of 3D objects, a second set of 2D images converted from a second group of 3D objects and layered with respect to the first set of 2D images, and a third set of 2D images converted from a third group of 3D objects and layered with respect to the first and second sets of 2D images, where the layering is according to a predetermined order and each group is comprised of similarly appearing 3D objects.

### BRIEF DESCRIPTION OF THE DRAWINGS

These and/or other aspects and advantages of the invention will become apparent and more readily appreciated from the following description of embodiments, taken in conjunction with the accompanying drawings of which:

FIGS. 1A through 1C are conceptual views for explaining a conventional method for processing 3-dimensional (3D) graphic data;

FIG. 2 is a flowchart of a method of processing 3D graphic data, according to an embodiment of the present invention; and

FIG. 3 is a block diagram of a system for processing 3D graphic data, according to an embodiment of the present invention.

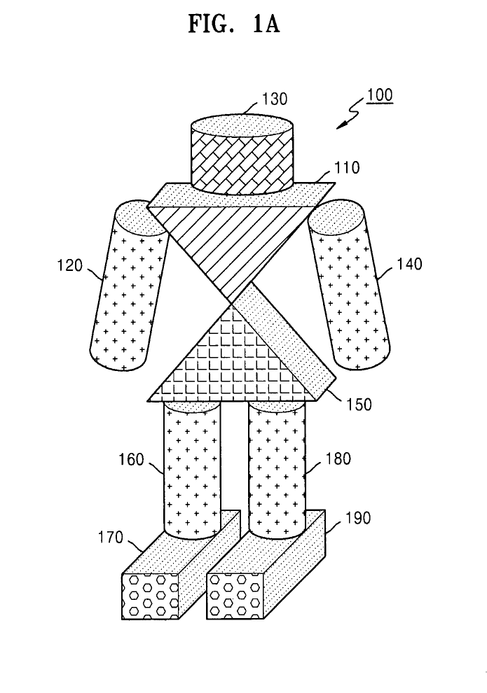

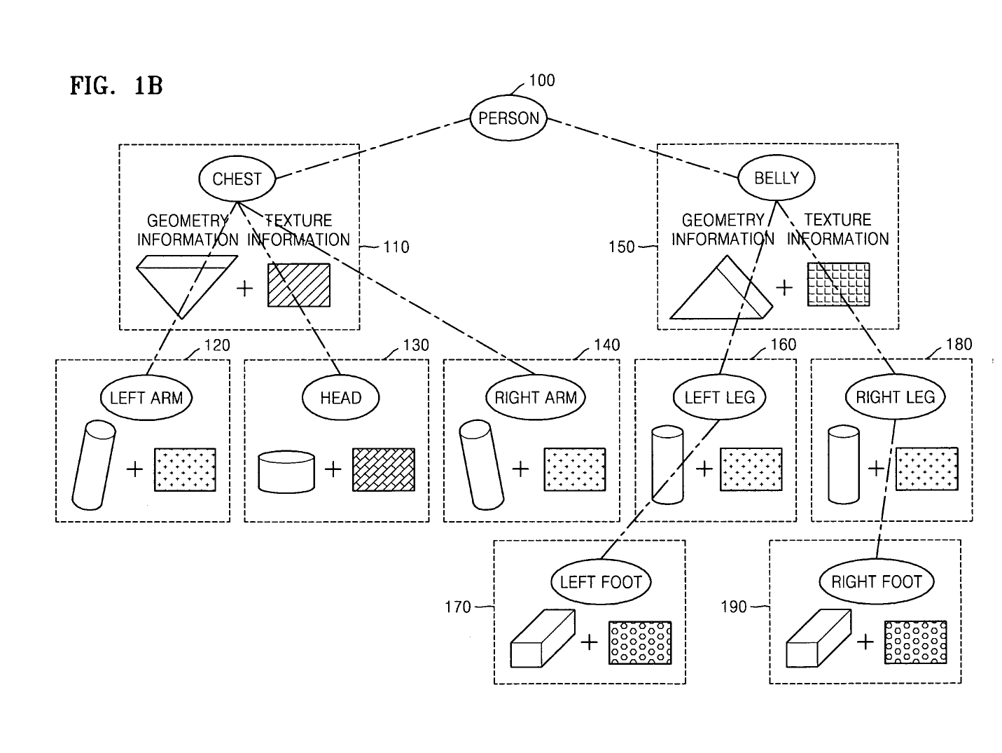

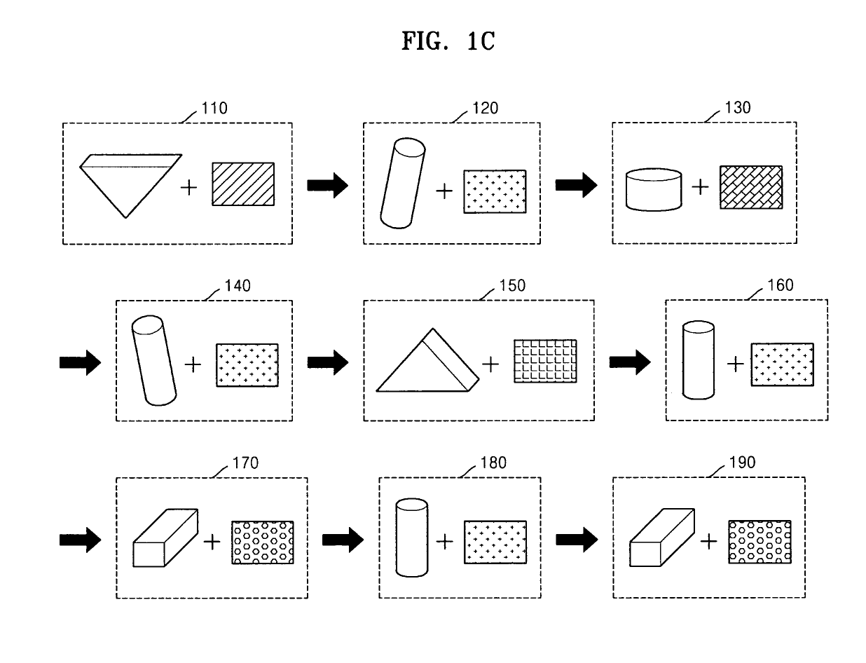

### DETAILED DESCRIPTION OF EMBODIMENTS

Reference will now be made in detail to embodiments of the present invention, examples of which are illustrated in the accompanying drawings, wherein like reference numerals refer to the like elements throughout. Embodiments are described below to explain the present invention by referring to the figures.

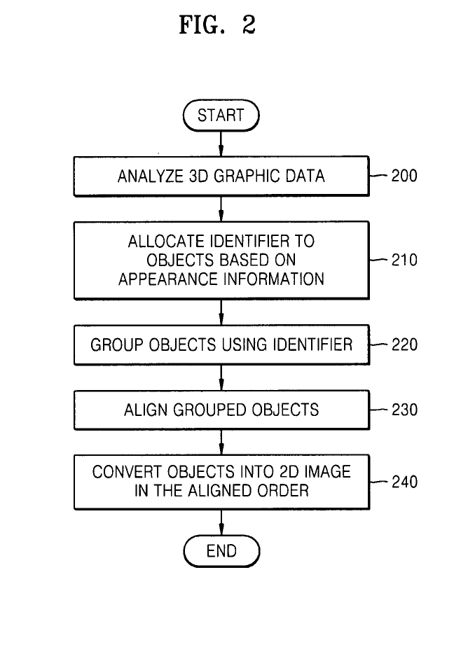

FIG. 2 is a flowchart of a method of processing 3-dimensional (3D) graphic data, according to an embodiment of the present invention.

First, 3D graphic data, such as virtual reality modeling language (VRML) or moving picture expert group (MPEG) data, may be analyzed in operation 200. Shape information for each object constituting the 3D graphic data may be analyzed in operation 200. Here, the shape information, which is managed by a graphic system, may indicate a shape of the object to be rendered.

The shape information may include geometry information and appearance information, for example. The geometry information may include information indicating locations of 3D points making up the object and connection information of the 3D points making up the object. The appearance information may include, for example, material information, texture information, and effects information including shader code.

An identifier may be allocated to each object based on the appearance information analyzed in operation 200, in operation 210. The identifier may be allocated to each object in consideration of not only basic information such as the material information and the texture information but also high level appearance information such as the effects information including the shader code. Accordingly, the method is available not only in a conventional fixed pipeline rendering engine but also in a shader pipeline rendering engine.

Here, the effects information may include information indicating a vertex pipeline and a pixel pipeline, both of which may be used for rendering the corresponding object. Special effects such as a multi-texture effect, a bump effect, an EMBM (Environment Mapped Bump Mapping) effect, a silhouette effect, a toon shading effect, and a user effect may be embodied in accordance with the method of practically embodying the vertex pipeline and the pixel pipeline.

The objects may be grouped using the identifiers allocated in operation 210, in operation 220.

The objects grouped in operation 220 may be aligned based on predetermined standards, in operation 230, to ensure layering of the objects occurs in the correct order. The aligned objects may be transmitted to the rendering pipeline in operation 230.

The objects grouped as transparent objects may be aligned prior to the objects grouped as opaque objects in operation 230, since the transparent objects may be separately processed in accordance with depth information after processing of the opaque objects. In addition, the transparent objects may be aligned in consideration of a view angle and a distance between a camera and the transparent object, in operation 230.

A rendering operation in which the object is expressed as the image by converting the objects into a 2D image in the aligned order in operation 230 may be performed in operation 240.

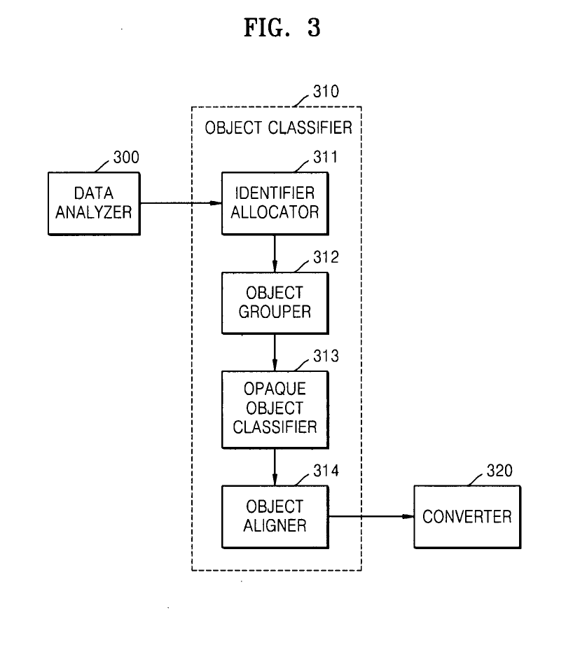

FIG. 3 is a block diagram of a system for processing 3D graphic data, according to an embodiment of the present invention. The system for processing the 3D graphic data may include a data analyzer 300, an object classifier 310, and a converter 320, for example.

The data analyzer 300 may analyze the 3D graphic data such as VRML and MPEG data in units of each object. Here, the data analyzer 300 may analyze the shape information included in each object.

The shape information, managed by the graphic system, may indicate a shape of the object to be rendered. The shape information may include the geometry information and the appearance information, for example. Here, the geometry information may include the information indicating the locations and the connection of the 3D points making up the object. The appearance information may include, for example, the material information, the texture information, and the effects information including the shader code.

The object classifier 310 may classify and align the objects analyzed by the data analyzer 300, based on the appearance information. Here, the object classifier 310 may include an identifier allocator 311, an object grouper 312, an opaque object classifier 313, and an object aligner 314, for example.

The identifier allocator 311 may allocate each object to the identifier based on the appearance information analyzed by the data analyzer 300. Here, the identifier allocator 311 may allocate the identifier to each object in consideration of not only basic information such as material information and texture information but also high level appearance information such as the effects information including, e.g., the shader code. Accordingly, the system may be available not only in the conventional fixed pipeline rendering engine but also in the shader pipeline rendering engine.

Here, the effects information may include information indicating a vertex pipeline and a pixel pipeline, both of which may be used for rendering the corresponding object. The special effects such as the multi-texture effect, the bump effect, the EMBM effect, the silhouette effect, the toon shading effect, and the user effect may be embodied according to the method of practically embodying the vertex pipeline and the pixel pipeline.

The object grouper 312 may group the objects using the identifiers allocated by the identifier allocator 311.

The opaque object classifier 313 may classify the objects into the objects grouped as transparent objects and the objects grouped as opaque objects, for example.

The object aligner 314 may align the objects grouped by the object grouper 312 based on the predetermined standards. The object aligner 314 may align the objects grouped as the transparent objects prior to the objects grouped as the opaque objects, since the transparent objects may be separately processed in accordance with depth information after processing of the opaque objects. In addition, the object aligner 314 may align the transparent objects in consideration of the view angle and the distance between the camera and the transparent object. Here, the object aligner may transmit the grouped objects to the rendering pipeline.

The converter 320 may perform the rendering operation in which the object is expressed as the image by converting the objects into the 2D image in the aligned order by the object aligner 314.

According to the system, method and medium, the objects of the 3D graphic data may be aligned and converted into a 2D image based on the appearance information corresponding to the effects information or shader code.

Accordingly, processing time for converting the 3D graphic data into the 2D image may be minimized by reducing the time for resetting the hardware whenever each object is rendered.

In addition, since one or more embodiments of the present invention may be available not only in the conventional fixed pipeline rendering engine but also in the shader pipeline rendering engine, one or more embodiments of the present invention may provide a software that is optimized for ease in scalability and can effectively use hardware to provide various combinations of surface processing for 3D graphics.

In addition to this discussion, one or more embodiments of the present invention may also be implemented through such software as computer readable code/instructions in/on a medium, e.g., a computer readable medium, to control at least one processing element to implement any above described embodiment. The medium can correspond to any medium/media permitting the storing and/or transmission of the computer readable code.

The computer readable code may be recorded/transferred on a medium in a variety of ways, with examples of the medium including magnetic storage media (e.g., ROM, floppy disks, hard disks, etc.), optical recording media (e.g., CD-ROMs, or DVDs), and storage/transmission media such as carrier waves, as well as through the Internet, for example. Here, the medium may further be a signal, such as a resultant signal or bitstream, according to one or more embodiments of the present invention. The media may also be a distributed network, so that the computer readable code is stored/transferred and executed in a distributed fashion. Still further, as only an example, the processing element may include a processor or a computer processor, and processing elements may be distributed and/or included in a single device.

Although a few embodiments of the present invention have been shown and described, it would be appreciated by those skilled in the art that changes may be made in these embodiments without departing from the principles and spirit of the invention, the scope of which is defined in the claims and their equivalents.

What is claimed is:

1. A method of processing 3D (3-dimensional) graphic data, the method comprising:
analyzing the 3D graphic data in units of each object;
classifying and aligning the analyzed objects based on appearance information; and
converting the analyzed objects into a 2D image in accordance with the alignment result.

2. The method of claim 1, wherein the appearance information comprises at least one of effects information and shader code.

3. The method of claim 2, wherein the aligning of the analyzed objects comprises:
allocating an identifier to each of the analyzed objects based on the appearance information;
grouping the analyzed objects using the allocated identifiers; and
aligning the grouped objects.

4. The method of claim 3,
wherein the aligning of the analyzed objects further comprises classifying the analyzed objects into transparent objects and opaque objects, and
wherein in the aligning of the analyzed objects, the transparent objects are aligned prior to the opaque objects.

5. At least one medium comprising computer readable code to control at least one processing element to implement the method of one of claims 1, 2, 3, or 4.

6. A system for processing 3D (3-dimensional) graphic data, the system comprising:
an analyzer analyzing the 3D graphic data in units of each object;
an object classifier to classify and to align the analyzed objects based on appearance information; and
a converter to convert the analyzed objects into a 2D image in accordance with the alignment result.

7. The system of claim 6, wherein the appearance information comprises at least one of effects information and shader code.

8. The system of claim 7, wherein the object classifier comprises:
an identifier allocator to allocate an identifier to each of the analyzed objects based on the appearance information;
an object grouper to group the analyzed objects using the allocated identifiers; and
an object aligner to align the grouped objects.

9. The system of claim 8,
wherein the object classifier further comprises an opaque object classifier to classify the analyzed objects into transparent objects and opaque objects, and
wherein the object classifier aligns the transparent objects prior to the opaque objects.

10. A method of processing 3D (3-dimensional) graphic data, the method comprising:
aligning 3D graphic objects in an order based on appearance of each of the objects; and
converting the objects into a 2D image in the aligned order.

11. The method of claim 10, further comprising allocating an identifier to each object and grouping the objects based on the allocated identifiers, and wherein the aligning comprises aligning the grouped objects.

12. The method of claim 11, further comprising aligning objects grouped as transparent objects prior to objects grouped as opaque objects.

13. The method of claim 10, wherein the appearance information comprises at least one of effects information and shader code.

14. The method of claim 10, further comprising analyzing the 3D graphic data in units of each of the objects.

15. The method of claim 10, wherein the aligning of the objects comprises:
allocating an identifier to each of the objects based on the appearance of the object;
grouping the objects using the allocated identifiers; and
aligning the grouped objects.

16. The method of claim 15,
wherein the aligning the objects further comprises classifying the objects into transparent objects and opaque objects, and
wherein in the aligning the objects, the transparent objects are aligned prior to the opaque objects.

17. At least one medium comprising computer readable code to control at least one processing element to implement the method of claim 10.

18. A display comprising:
a first set of 2D images converted from a first group of 3D objects;
a second set of 2D images converted from a second group of 3D objects and layered with respect to the first set of 2D images; and
a third set of 2D images converted from a third group of 3D objects and layered with respect to the first and second sets of 2D images, where the layering is according to a predetermined order and each group is comprised of similarly appearing 3D objects.
